(19) United States
(12) Patent Application Publication
(10) Pub. No.: US 2006/0140582 A1
(43) Pub. Date: Jun. 29, 2006

(54) Recording and playback device and programmed recording program

(75) Inventor: Masaru Shibata, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/315,211

(22) Filed: Dec. 23, 2005

(30) Foreign Application Priority Data
Dec. 27, 2004 (JP) 2004-377495

(51) Int. Cl. H04N 5/91

(52) U.S. Cl. 386/83

(57) ABSTRACT

To provide a recording and playback device for simplifying setting operation of programmed recording of a series of programs associated with each other (for example, drama series) and enabling to associate the plural recording media each other when the series of programs are recorded across the plural recording media. The present invention records “programmed recording setting information” on a disc at the programmed recording setting process, obtains the “programmed recording setting information” from the disc and performs programmed recording setting process by using the information at the following programmed recording setting process. When discs are exchanged, the present invention records a disc ID of each one of the new and old discs on the other disc and records “programmed recording setting information” carried over from the old disc on the new disc to simplify programmed recording setting operation and associate a plurality of discs each other when discs are exchanged.

The present application is based on and claims priority of Japanese patent application No. 2004-377495 filed on Dec. 27, 2004, the entire contents of which are hereby incorporated by reference.

### BACKGROUND OF THE INVENTION

1. Field of the Invention

The present invention relates to a recording and playback device, and specifically to a recording and playback device that takes into account of the case where a series of contents are divided and recorded on plural recording media.

2. Description of the Related Art

In a recording and playback device for recording contents (such as broadcasted program) on a recording medium, so-called “programmed recording” is widely employed. The “programmed recording” automatically records a program when starting time of recording, finishing time of recording, selection of an input source (channel or the like) and the like are preset and stored. Although the programmed recording is a convenient function, the setting operation is complicated to some extent. In addition, if a user wants to “record a certain program on a certain recording medium”, it is sometimes troublesome for the user to check the recording medium (for example, check the program recorded on the medium by playing the program).

Conventional arts for simplifying the programmed recording setting operation or simplifying the operation of checking the contents on the recording medium (selection of the medium) by recording programmed recording information on a recording medium are disclosed by Japanese Patent Laid-Open Publication No. 4-188454, Japanese Patent Laid-Open Publication No. 10-69756, Japanese Patent Laid-Open Publication No. 2001-266471 and Japanese Patent Laid-Open Publication No. 2002-369111 (patent documents 1 to 4).

Some programs are regularly (for example, once a week) broadcasted under the same title with different contents (for example, dramas). In performing programmed recording such regularly broadcasted programs under the same title, the abovementioned conventional arts simplify setting operation and the like and outstandingly improve operability, as the information is already stored in the recording medium for a user to use the information in setting the programmed recording. The conventional arts basically save programmed recording information on a single recording medium. Therefore, a user has to record the programmed recording information on respective recording media if programs under the same title are recorded on plural recording media. The conventional arts cannot associate the plural recording media containing programs under the same title with each other. The conventional arts cannot indicate what number each program is in the whole programs (in all the programs under the same title) recorded on the plural recording medium.

### SUMMARY OF THE INVENTION

In view of the abovementioned problems, the present invention intends to provide a recording and playback device for simplifying programmed recording setting operation of a series of programs associated with each other (for example, programs under the same title) and enabling to associate the plural recording media each other when the series of programs are recorded across the plural recording media.

A first aspect of the recording and playback device is a recording and playback device for recording programs regularly broadcasted or sent, which consists of a series of programs associated with each other, on a recording medium; wherein each program of the series of programs is given serial number information and recorded in the recording medium.

According to the above configuration, as each program of the series of programs is given serial number information when the series of programs associated with each other (for example, programs under the same title) is recorded, what number each program is recorded in the series of programs associated with each other (for example, programs under the same title) can be displayed in such a time of playing the recording medium.

A second aspect of the recording and playback device is the recording and playback device of the first aspect, wherein when capacity required for recording the programs consisting of the series of programs associated with each other exceeds capacity of a single unit of the recording medium and the programs are divided and recorded on a plurality of recording media, each of the programs recorded on the plurality of recording media is serially given the serial number information and recorded on each of the plurality of recording media.

According to the above configuration, as each program recorded on the plurality of recording media is given serial number information and recorded on a recording medium even when a series of programs associated with each other (for example, programs under the same title) are recorded on plural recording media, what number each program in the plurality of recording media is in the whole programs (in the programs under the same title) can be determined.

A third aspect of the recording and playback device is a recording and playback device for enabling recording operation of a program on a recording medium to be performed by programmed recording operation by previously setting and storing start date and time of recording and finish date and time of recording and selection of an input source of image signals to be recorded; wherein when the programs are the programs consisting of a series of programs regularly broadcasted or sent associated with each other, programmed recording setting information such as the start date and time of recording and the finish date and time of recording and the input source of the image signals is recorded on the recording medium so that the recorded programmed recording setting information is used in setting the next programmed recording; and wherein when the recording medium is exchanged with another recording medium in the case where capacity required for recording the programs consisting of a series of programs associated with each other exceeds capacity of a single unit of the recording medium and the programs are divided and recorded on the plurality of recording media, the programmed recording setting information is carried over and recorded on the next recording medium.

According to the above configuration, programmed recording setting information is carried over and recorded on a new recording medium even if programs are recorded across a plurality of recording media.

A fourth aspect of the recording and playback device is the recording and playback device of the third aspect, wherein when each program of the series of programs are recorded, each program is given serial number information and recorded on the recording medium; and wherein when capacity required for recording the programs consisting of the series of programs associated with each other exceeds capacity of a single unit of the recording medium and the programs are divided and recorded on the plurality of recording media, programs to be recorded on the plurality of recording media are serially given the serial number information and recorded on the plurality of recording media.

According to the above configuration, when a recording medium is exchanged with another recording medium, programmed recording setting information is carried over and recorded on a new recording medium and a series of programs associated with each other to be recorded on a plurality of recording media are given serial numbers, even in a case where programs are recorded on a plurality of recording media.

A fifth aspect of the recording and playback device is the recording and playback device of any one of the first, second and fourth aspects, wherein the serial number information is used as a part of title information when the program is recorded on the recording medium.

According to the above configuration, the serial number information is used as a part of title information (for example, a title name such as “XX Drama 7” can be generated by using serial number information in the title and recorded).

A sixth aspect of the recording and playback device is the recording and playback device of any one of the second aspect to the fourth aspect, wherein medium identifying information for identifying a medium, on which programs immediately before or immediately after are recorded, is recorded on each of the plurality of recording media.

According to the above configuration, when a series of programs associated with each other are recorded on a plurality of recording media, the recording media can be associated with each other as medium identifying information of the recording medium, on which programs immediately before or immediately after are recorded, is recorded on each recording medium.

A seventh aspect of the recording and playback device is the recording and playback device of any one of the first aspect to the sixth aspect, wherein the recording and playback device is a recording and playback device for recording a program on a recording medium in a recording method complying with a DVD Video Recording format, and the serial number information or the programmed recording setting information or the medium identifying information or a combination of the information are stored in Manufacturer's Information Table area in the DVD Video Recording format.

According to the above configuration, in the DVD Video Recording (DVD-VR) format, serial number information or programmed recording setting information or medium identifying information are stored in the Manufacturer's Information Table area, which is an area basically allowed for a manufacturer to use arbitrarily.

An eighth aspect of a programmed recording program causes a micro computer provided in a recording and playback device for enabling recording operation of a program on a recording medium to be performed by programmed recording operation by previously setting and storing start date and time of recording and finish date and time of recording and selection of an input source of image signals to be recorded, to execute the steps of: recording programmed recording setting information and serial number information of a program on a first recording medium when programmed recording of the program on the first recording medium is set; using programmed recording setting information recorded on the first recording medium when programmed recording of following programs is set for the first recording medium, and when capacity required for the programmed recording is less than free capacity of the first recording medium, using the programmed recording setting information for setting programmed recording; when the capacity required for the programmed recording exceeds the free capacity of the first recording medium, recording the medium identifying information of a second recording medium on the first recording medium and asking a user to exchange the first recording medium with the second recording medium, and when the first recording medium is exchanged with the second recording medium, recording the programmed recording setting information, the medium identifying information and the serial number information of the first recording medium on the exchanged second recording medium and setting programmed recording by using the programmed recording setting information; and updating the serial number information by using the serial number information as a part of title information in recording process of the programmed recording.

### BRIEF DESCRIPTION OF THE DRAWINGS

FIG. 1 is a block diagram showing an outline of only a part relating to the present invention in a LCD with a built-in DVD recording and playback device;

FIG. 2 is a perspective view of the LCD with a built-in DVD recording and playback device;

FIG. 3 is a flowchart for showing an outline of programmed recording setting process operated by the LCD with a built-in DVD recording and playback device;

FIG. 4 is a flowchart for showing an outline of programmed recording setting process operated by the LCD with a built-in DVD recording and playback device;

FIG. 5 is a flowchart for showing an outline of programmed recording setting process operated by the LCD with a built-in DVD recording and playback device;

FIG. 6 is a diagram showing an example of a display screen of the LCD with a built-in DVD recording and playback device;

FIG. 7 is a schematic diagram for describing searching operation in the recording and playback device provided with a changer mechanism;

FIG. 8 is a diagram showing a part of a file configuration of the DVD Video Recording format;

FIG. 9 is a diagram showing a part of a file configuration of an intermediate format in the DVD-Video format; and

FIG. 10 is a diagram showing a part of a file configuration in the DVD Video Recording format.

### DETAILED DESCRIPTION OF THE PREFERRED EMBODIMENTS

Specific embodiment of the present invention will be described with reference to the drawings. The embodiment below is an example for implementing the present invention and not limit the present invention to the range of the embodiment.

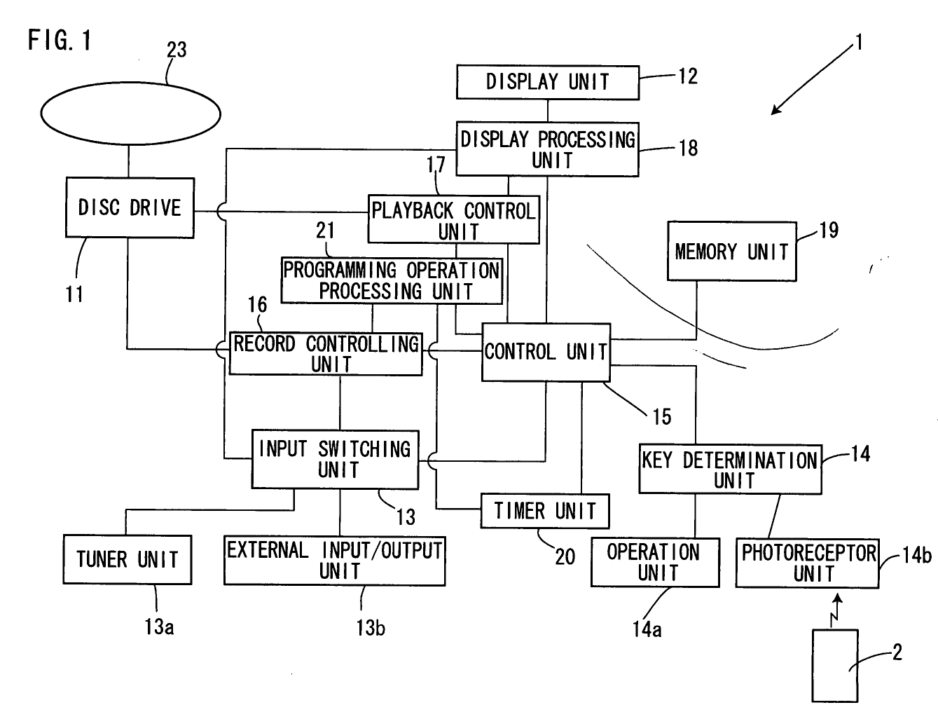

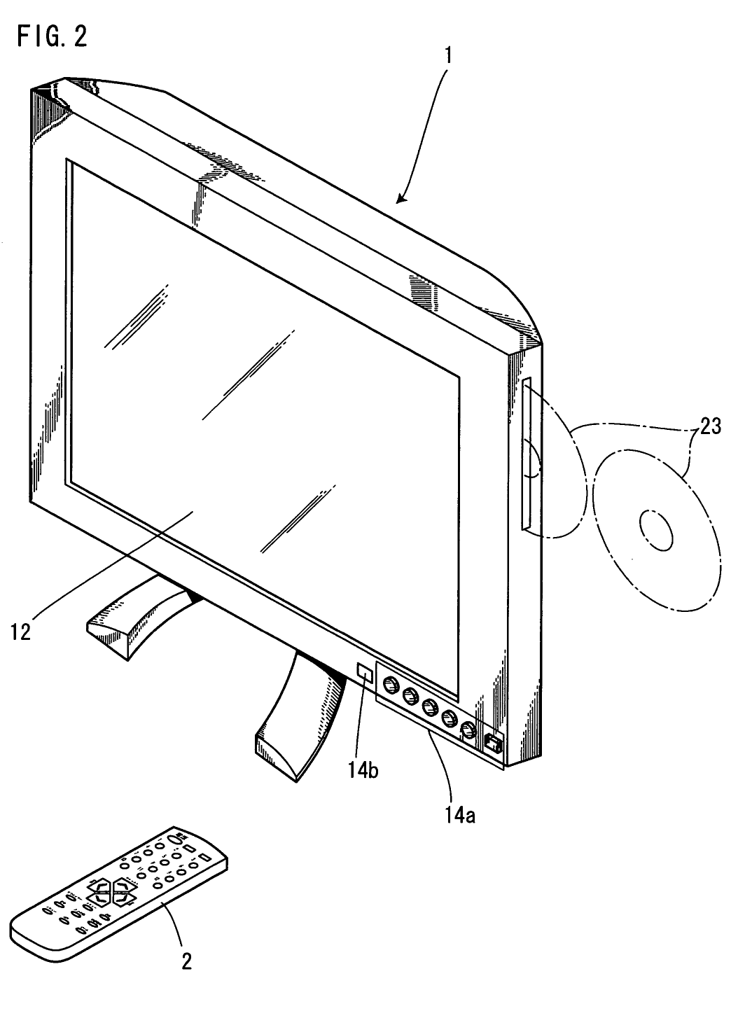

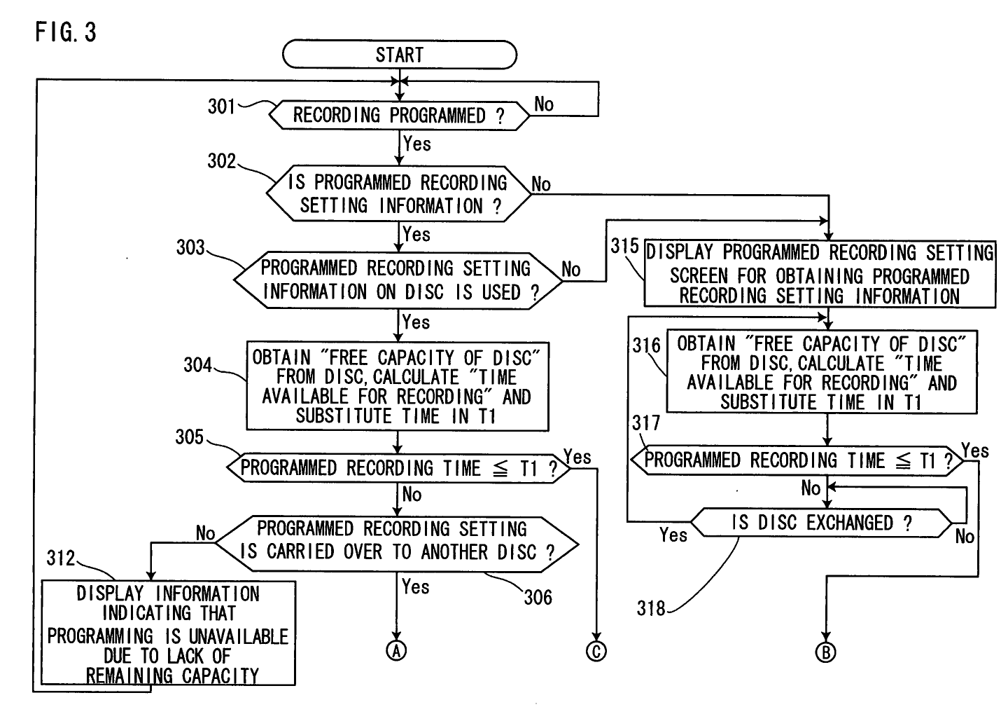

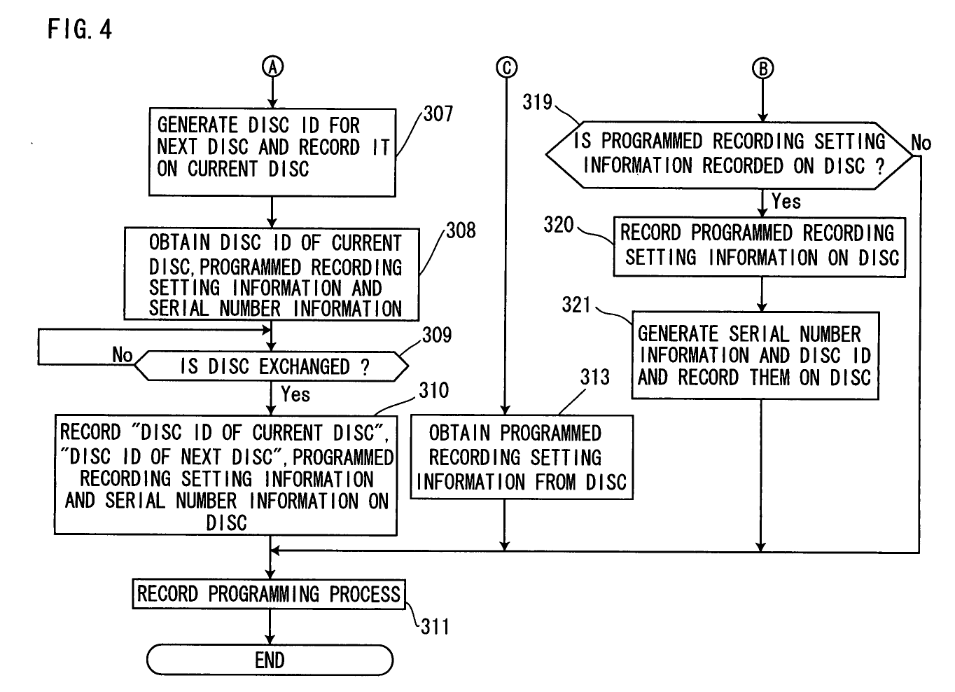

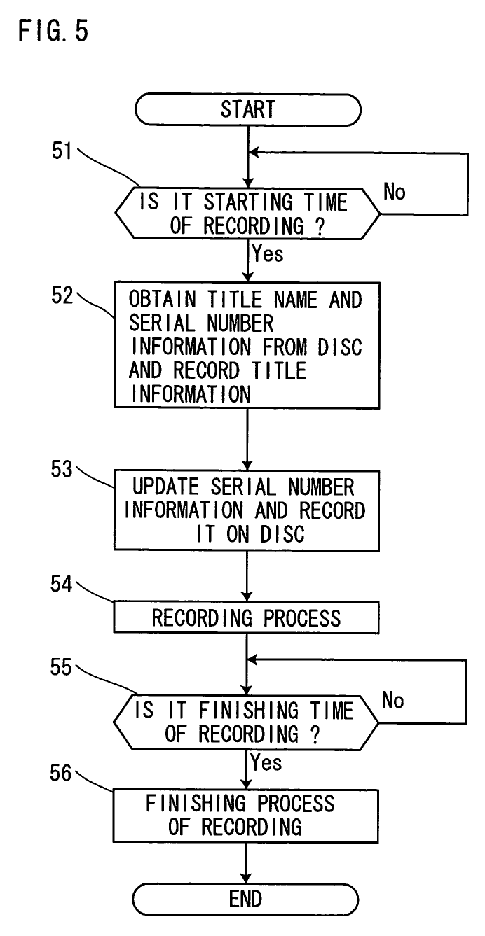

FIG. 1 is a block diagram showing an outline of only a part relating to the present invention in a LCD with a built-in DVD recording and playback device of the embodiment. FIG. 2 is a perspective view of the LCD with a built-in DVD recording and playback device. FIG. 3, FIG. 4 and FIG. 5 are flowcharts for showing an outline of operation of a part relating to the present invention.

As shown in FIG. 1, the LCD with a built-in DVD recording and playback device of the embodiment (hereinafter simply referred to as the LCD with a built-in DVD) 1 has a disc drive 11 for reading and writing a signal to and from a DVD 23 which is a recording medium, a display unit 12, an input switching unit 13 for switching and outputting a signal from a tuner unit 13a or an external input/output unit 13b, a key determination unit 14 for determining and outputting a signal from an operation unit 14a or a photo receptor unit 14b, a control unit 15 for controlling over the device, and the like. The LCD 1 with a built-in DVD also includes a record controlling unit 16 provided with an encoder for converting an image sound signal inputted from the input switching unit 13 into a signal complying with the MPEG standard and a function of generating record data complying with the standard of the DVD-VR format, a playback control unit 17 provided with a decoder or the like for decompressing data inputted from the disc drive 11, a display processing unit 18 for displaying image signals inputted from the input switching unit 13 or the playback control unit 17 on the display unit 12, a memory unit 19, a timer unit 20 with a clocking function and a programming operation processing unit 21 for processing programming operation.

Now, an outline of programmed recording setting process operated by the LCD 1 with a built-in DVD of the embodiment will be described with reference to FIG. 3 and FIG. 4. At step 301, the LCD 1 waits for an instruction for setting programmed recording (start of programmed recording setting by a user operating a remote control unit 2 or the operation unit 14a). When the instruction is received, operation proceeds to step 302. Various types of instructions and information from a user are determined and obtained by the key determination unit 14 and the control unit 15 when the user operates the remote control unit 2 or the operation unit 14a according to a display screen (the display unit 12 or a display unit provided for the remote control unit 2). Various types of instructions and information in the description of operation are also the same as this.

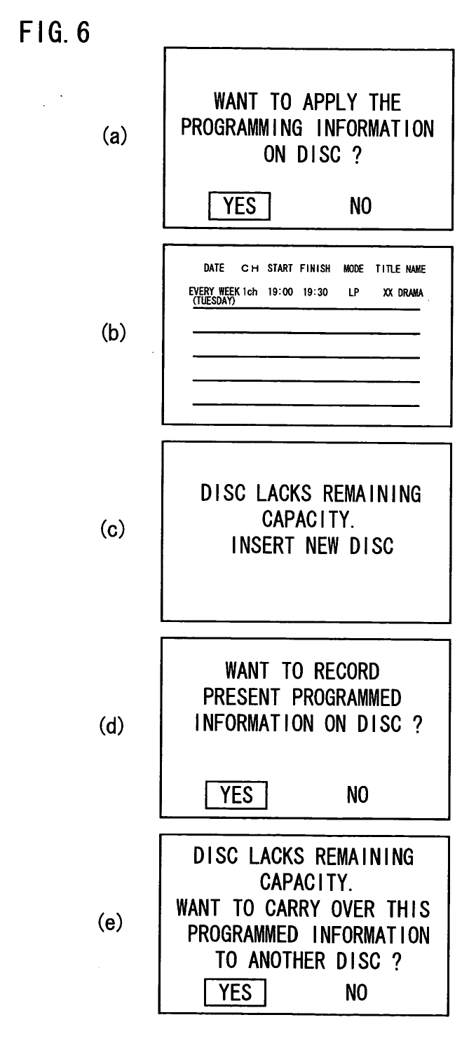

At step 302, the LCD 1 determines whether programmed recording setting information to be described later is recorded on the DVD 23 or not. If the information is recorded, operation proceeds to step 303. If the information is not recorded, operation proceeds to step 315. The LCD 1 performs the determining operation by decoding and determining signals obtained from the DVD 23 through the disc drive 11 and the playback control unit 17 by the programming operation processing unit 21 and the control unit 15 (the operation is the same as this when information is obtained and determined from the DVD 23 in the operation below). At step 303, a screen such as one shown as FIG. 6(A) is displayed for asking a user to determine whether or not to use programmed recording setting information recorded on the DVD 23 to set programmed recording. If the user does not want to use the information, operation proceeds to step 315.

At step 315, a screen such as one shown in FIG. 6(B) is displayed for obtaining programmed recording setting information. The “programmed recording setting information” in the embodiment as shown in the figure includes recording date (a particular date, “everyday”, “every Tuesday” or the like), starting time of recording, finishing time of recording, input source (channel or the like), image quality mode (high image quality or low image quality), and title name (program name). At the following step 316, the LCD 1 obtains information on free capacity of the disc from the DVD 23, calculates “time available for recording (time available for recording on the DVD 23)”, substitutes the time in a variable T1 and stores it in the memory unit 19. The LCD 1 calculates “time available for recording” by subtracting an average bit rate from the free capacity, for example. The LCD 1 compares T1 with “programmed recording time” calculated from “programmed recording setting information” obtained at step 315 (step 317). If the programmed recording time is longer, the LCD 1 displays a screen such as one shown in FIG. 6(C) for prompting a user to exchange the DVD 23 with a new one. When the disc is exchanged to the new one, operation returns to step 316 and repeats the process (step 318). If the programmed recording time is shorter at the comparison at step 317, the LCD 1 displays a screen such as one shown in FIG. 6(D) at step 319 for asking a user to select whether or not to record the “programmed recording setting information” on the DVD 23. If the user selects to record the information on the DVD 23, the LCD 1 records the “programmed recording setting information” on the DVD 23 at step 320, generates “serial number information” and “disc ID” and records them on the DVD 23 (step 321). Then, operation proceeds to record programming process at step 311 (record programming operation by using programmed recording setting information obtained at step 315). If the determination is No at step 319, operation immediately proceeds to record programming process at step 311 and finishes the programming setting process. The “serial number information” is a number given to each program of a series of programs (for example, a program broadcasted at each time of the programs under the same title broadcasted every week). The “disc ID” is medium identifying information for identifying a medium. In the embodiment, each of the information is number information such as “0001”.

If the determination at step 303 is Yes (to set programmed recording by using programmed recording setting information recorded on the DVD 23), operation proceeds to process at step 304 and step 305 (the same process as the abovementioned step 316 and step 317). If the determination at step 305 is Yes (the programmed recording time is shorter than the time available for recording on the DVD 23), operation proceeds to step 313, where the LCD 1 obtains the “programmed recording setting information” from the DVD 23, performs record programming process by using the information (step 311) and finishes the programming setting process. When the “programmed recording setting information” obtained from the DVD 23 is used, starting time of recording, finishing time of recording, input source (channel or the like), image quality mode (high image quality or low image quality), title name (program name) are used as they are. The information indicating a particular date such as 31st cannot be used as it is. In such a case, the LCD 1 uses the recording date information by processing as required or asks a user to input or select information as required (if the recording date is such information as “everyday” or “every Tuesday”, it can be used as it is). The LCD 1 may ask a user to input or select each item of “programmed recording setting information” or “serial number information” such as an image quality mode to change them as required.

If the determination at step 305 is No (the programmed recording time is longer than the time available for recording on the DVD 23), the LCD 1 displays a screen such as one shown in FIG. 6(E) for asking the user to select whether or not to carry over the programmed recording setting information to another disc (step 306). If the determination at step 305 is Yes, the LCD 1 generates a disc ID for the next disc (if the disc ID for the current disc is “0002”, generates “0003”) and records information indicating that “the next disc is “0003” on the current disc (DVD 23) (step 307). At the following step 308, the LCD 1 obtains the disc ID of the current disc (“0002” in the above example), the programmed recording setting information, the serial number information from the DVD 23 and stores them in the memory unit 19. At the following step 309, the LCD 1 displays information indicating that “Insert a new disc” on a screen and waits for the user to exchange discs. When a new disc is inserted, the LCD 1 records “the previous disc is “0002” on the disc as “the disc ID of the current disc (“0002” in the above example)”, records “the disc ID of the next disc (“0003” in the above example)” as the disc ID of the disc, and records “programmed recording setting information” and “serial number information” (step 310). At the following step 311, the LCD 1 performs record programming process by using the programmed recording setting information and finishes the programming setting process. If the determination at step 306 is No (not to carry over the information to another disc), the LCD 1 displays information indicating that “programming setting is unavailable due to lack of remaining capacity of the disc” on the screen (step 312). Then, operation returns to step 301 and repeat the process.

Through the above process, programmed recording setting information and serial number information are recorded on a recording medium (DVD), and if a recording medium, on which the programmed recording setting information is recorded, is inserted in the device, the programmed recording setting information recorded on the recording medium can be used for performing programmed recording. If the recording medium needs to be exchanged with a new one due to lack of storage capacity, the programmed recording setting information and serial number information are carried over to and stored in the new recording medium, and the medium identifying information indicating “the previous medium” and that indicating “the next medium” are stored in respective recording media on which programs before and after the current medium are recorded.

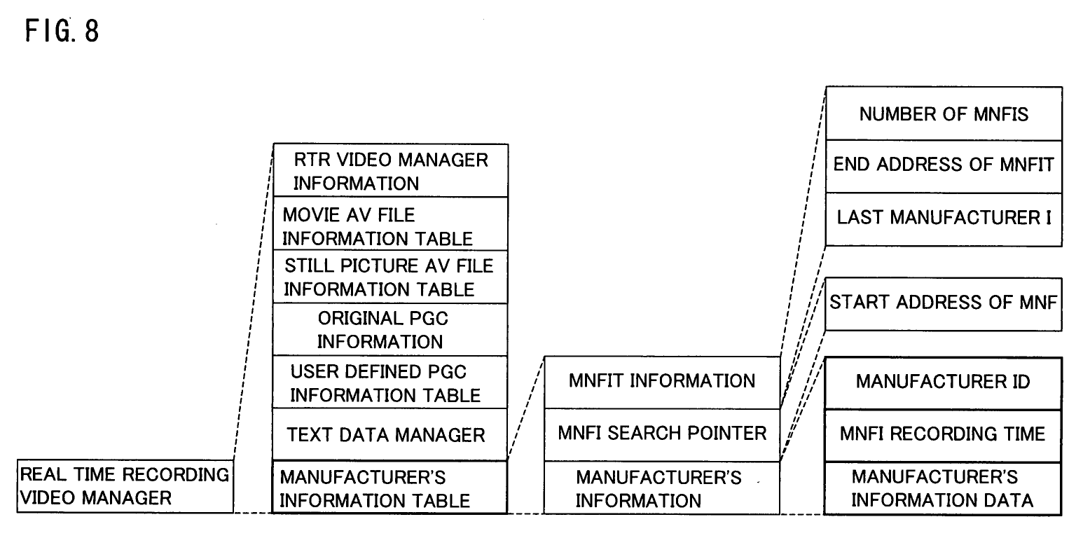

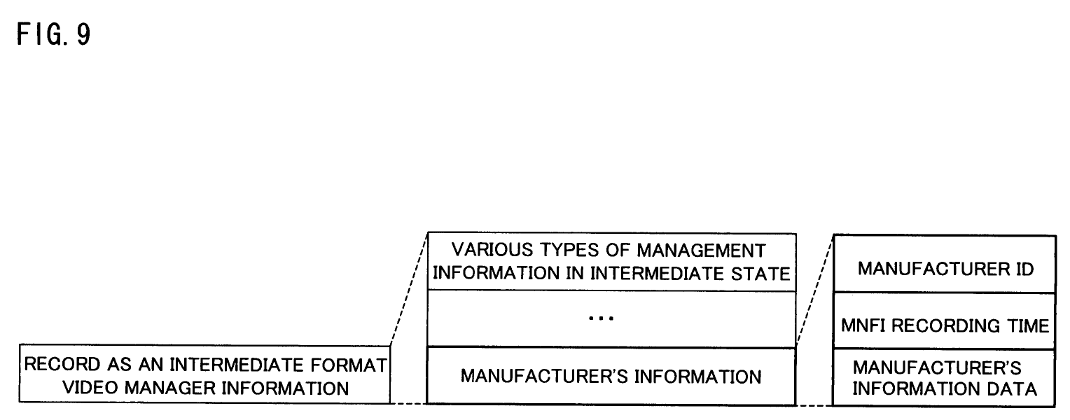

A specific example of storage of programmed recording setting information, serial number information or medium identifying information on the DVD 23 is in the Manufacturer's Information Data area (basically an area available for the manufacturer) in Manufacturer's Information in Manufacturer's Information Table area in the DVD Video Recording format. In the DVD-Video format, programmed recording setting information, serial number information or medium identifying information is recorded and stored in an intermediate format before being finalized. The intermediate format records necessary management information in a method specific to the manufacturer (at least a file configuration after being finalized needs to comply with the standard of the DVD-Video format, and the intermediate format is in a configuration specific to each manufacturer), and can store the abovementioned various types of information (programmed recording setting information, serial number information, medium identifying information and the like) in the area for recording the management information. A specific example of the area is in the Manufacturer's Information Data area created in the Manufacturer's Information area for recording manufacturer information in an area for recording management information. FIG. 8 shows a part of a file configuration of the DVD Video Recording format (a part including the Manufacturer's Information Data area). FIG. 9 shows a part of a file configuration of an intermediate format in the DVD-Video format (a part including the Manufacturer's Information Data area).

Now, mainly an outline of only a part relating to the present invention in operation of programmed recording process of the LCD 1 with a built-in DVD of the embodiment will be described with reference to FIG. 5. When programmed recording is set, the LCD 1 waits for the starting time of recording at step 51 (the current time obtained by the timer unit 20 and the starting time of programmed recording are compared and determined at the control unit 15 and the programming operation processing unit 21). When the starting time of recording comes, the LCD 1 obtains a title name, which is the “programmed recording setting information”, and the “serial number information” from the DVD 23, creates title information of the program to be recorded and records the information on the DVD 23 (step 52). At the following step 53, the LCD 1 updates the “serial number information” (for example, the information “0007” is updated to “0008”), records the information on a disc (DVD 23) and performs recording process (step 54). At step 55, the LCD 1 waits for the finishing time of recording. When it is determined that the finishing time comes, the LCD 1 performs finishing process of the recording (step 56) and finishes the process. As it actually takes some time to perform the process of from step 52 to step 53, the “starting time of recording” at step 51 is a little bit earlier than the set starting time of programmed recording and the starting time of recording at step 54 is the “set starting time of programmed recording”.

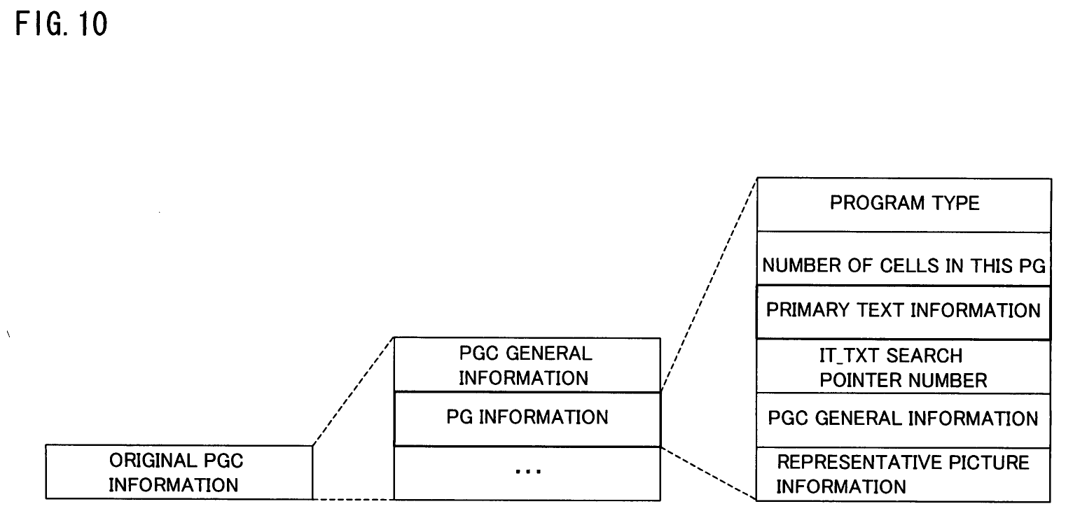

Though the abovementioned process, each program is given serial number information and stored on a recording medium (DVD 23). In other words, when the tile name is “XX Drama” in the “programmed recording setting information” and the “serial number information” is “0007”, for example, the LCD 1 can take process such as generating the title name “XX Drama 7” by giving the serial number information to the title name and recording the title name in the DVD 23 as title information (the title name and the serial number can be recorded in the title information as separate pieces of information) (Information such as the title name recorded in the disc can be changed later by editing operation or the like as required). A specific example of an area for recording a title name or serial number information as the “title information” of each program is in the Primary Text Information area in PG Information in Original PGC Information area in the DVD Video Recording format. FIG. 10 shows a part of a file configuration in the DVD Video Recording format (a part including the Primary Text Information area).

As mentioned above, according to the LCD 1 with a built-in DVD of the embodiment, when a recording medium is exchanged with a new recording medium in a case where programs are recorded across a plurality of recording media, programmed recording setting information is carried over to the new recording medium. Therefore, if only a user performs programmed recording setting operation on a first recording medium, the first programmed recording setting information can be used when programmed recording is set for the following second and third recording media. This simplifies programmed recording setting operation. When programmed recording setting information is recorded on a recording medium and a user operates to set programmed recording, the embodiment is adapted to ask the user to select whether or not to use the information (steps 301-303 in FIG. 3). The present invention can be adapted to automatically enter in programmed recording state, for example, when a recording medium, on which programmed recording setting information is recorded, is inserted in the device. This further simplifies the operation.

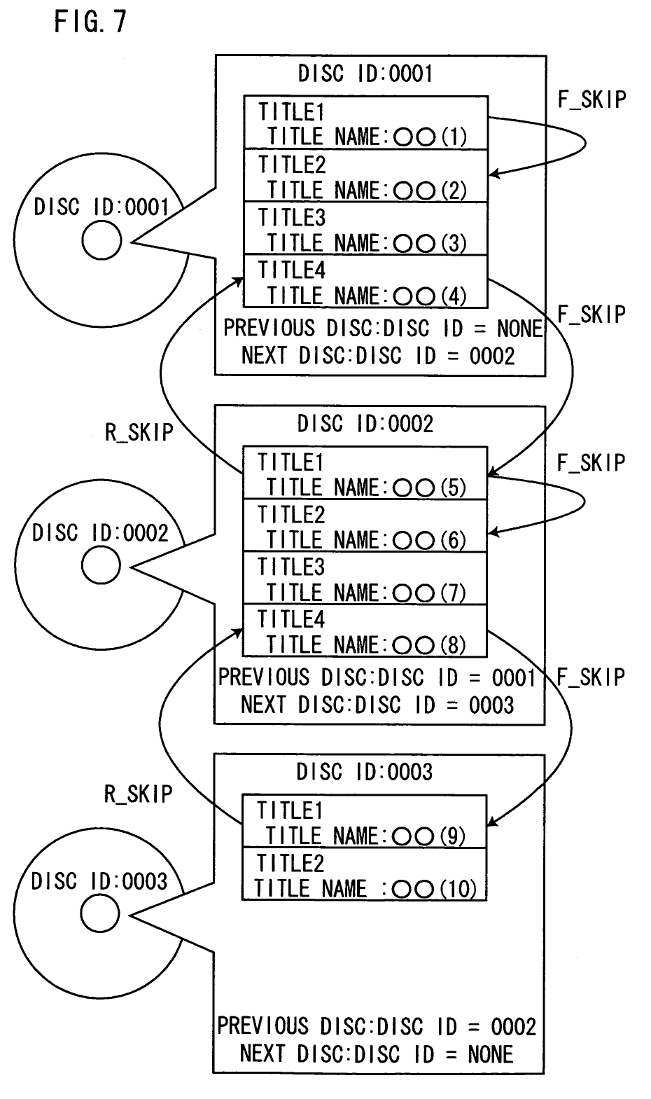

Even if programs are recorded across a plurality of recording media, the programs are given serial number information and recorded so that what number each program is in the whole programs (in the programs under the same title) can be determined (i.e., If the programs under the same title are recorded across ten DVDs, for example, what number a certain program in the third DVD is in the whole programs can be displayed.). This is quite convenient for a user. Additionally, as each recording medium records medium identifying information (disc ID) for recording media, on which programs before and after those recorded on the medium are recorded, all the recording media can be associated with each other. Therefore, when a plurality of recording media (a plurality of recording media on which a series of programs associated with each other are recorded) are stored in a device provided with a so-called changer mechanism, for example, searching operation or the like across media can be performed easily and quickly. FIG. 7 shows a schematic diagram for describing process of searching operation in the device provided with a changer mechanism. As shown in the figure, a user is watching “Disc 0001”, for example, and wants to search “the next title” as the playback of title four finishes. As the disc ID of “Disc 0002” is recorded as “the next disc” on the “Disc 0001”, the user can recognize “Disc 0002” as the next disc (similarly, “the previous disc” canal so be recognized). That is to say, whatever order discs are put in the changer device, the discs can be played back (searched) in the correct order.

Although Manufacturer's Information Data area is exemplified for storing the current “serial number” as a (specific example of) a recording area of the “serial number information”, in addition to a Primary Text Information area in the DVD Video Recording format (for recording “serial number information” as “title information”) in the embodiment, the “serial number information” is not necessarily recorded separately from “title information” to store the current “serial number”. The present invention can be adapted to obtain and use “serial number information” recorded as “tile information”, if only the “serial number information” is recorded as the “tile information” (the present invention obtains “serial number information” by referencing the “title information” at step 52 in FIG. 5). The “programmed recording setting information” to be recorded on a recording medium is not limited to a single piece, and “programmed recording setting information” for plural programs can be recorded on a recording medium. In such a case, “serial number information” is preferably given to each program. Although the device is adapted to generate and give “disc ID” in the embodiment, “medium identifying information” recorded on the disc when the disc medium is manufactured can be used instead.

Although a LCD with a built-in DVD is used as a specific example of a “recording and playback device” in the embodiment, the present invention is not limited to this. The recording medium may include an optical disc medium other than DVD, a magnetic disc medium represented as an HDD, and recording medium made of semiconductor devices such as flash memory. The “recording and playback device” according to the present invention is a recording and playback device for the abovementioned recording medium. As it is apparent from the embodiment (the LCD 1 with a built-in DVD), the “recording and playback device” in the present invention is not limited to a device for only performing recording/replaying an image to/from a recording medium, and include a complex device such as one integrated with the other functions.

According to a recording and playback device for recording programs regularly broadcasted or sent, which consists of a series of programs associated with each other, on a recording medium; wherein, when each program of the series of programs is recorded, each program of the series of programs is given serial number information and recorded in the recording medium, of the first aspect of the present invention, what number each program is recorded in the series of programs associated with each other (for example, programs under the same title) can be displayed so that a user can recognize what number each program is in the series of programs in such a time of playing a program (seventh program of a XX Drama, for example). This is quite convenient for a user.

According to the recording and playback device according to the second aspect, wherein when capacity required for recording the programs consisting of the series of programs associated with each other exceeds capacity of a single unit of the recording medium and the programs are divided and recorded on the plurality of recording media, each of the programs to be recorded on the plurality of recording media is serially given the serial number information and recorded on each of the plurality of recording media, of the second aspect of the present invention, what number each program recorded across a plurality of recording media is in the whole programs (in the programs under the same title) can be determined (i.e., when programs under the same title are recorded in ten DVDs, what number a certain program recorded on the third DVD is in the whole programs can be displayed). This is quite convenient for a user.

According to the recording and playback device for enabling recording operation of a program on a recording medium to be performed by programmed recording operation by previously setting and storing start date and time of recording and finish date and time of recording and selection of an input source of image signals to be recorded; wherein when the programs are the programs consisting of a series of programs regularly broadcasted or sent associated with each other, programmed recording setting information such as the start date and time of recording and the finish date and time of recording and the input source of the image signals is recorded on the recording medium so that the recorded programmed recording setting information is used in setting the next programmed recording; and wherein when the recording medium is exchanged with another recording medium in the case where capacity required for recording the programs consisting of a series of programs associated with each other exceeds capacity of a single unit of the recording medium and the programs are divided and recorded on the plurality of recording media, the programmed recording setting information is carried over and recorded on the next recording medium, of the third aspect of the present invention, programmed recording setting information is carried over and recorded on a new recording medium when recording media are exchanged even if programs are recorded across a plurality of recording media so that if a user only performs programmed recording setting operation on the first recording medium, the first programmed recording setting information can be used when programmed recording setting process is performed for the following second and third recording medium. This simplifies programmed recording setting operation.

According to the recording and playback device of any one of the second aspect to the forth aspect, where in medium identifying information for identifying a medium, on which programs immediately before or immediately after are recorded, is recorded on each of the plurality of recording media of the sixth aspect of the present invention, when a series of programs associated with each other are recorded on a plurality of recording media, the recording media can be associated with each other as medium identifying information of the recording medium, on which programs immediately before or immediately after are recorded, is recorded on each recording medium. Therefore, when a plurality of recording media (a plurality of recording media recording a series of programs associated with each other) are stored, for example, in a device provided with so-called a changer mechanism, searching operation across the media can be processed easily and quickly (because each recording medium records medium identifying information on media, on which programs immediately before or immediately after are recorded, and a medium whose playing order is “immediately before” or “immediately after” can be quickly determined).

1. A recording and playback device for recording programs regularly broadcasted or sent, which consists of a series of programs associated with each other, on a recording medium; wherein, when each program of the series of programs is recorded, each program of the series of programs is given serial number information and recorded in the recording medium.

2. The recording and playback device according to claim 1, wherein when capacity required for recording the programs consisting of the series of programs associated with each other exceeds capacity of a single unit of the recording medium and the programs are divided and recorded on a plurality of recording media, each of the programs to be recorded on the plurality of recording media is serially given the serial number information and recorded on each of the plurality of recording media.

3. A recording and playback device for enabling recording operation of a program on a recording medium to be performed by programmed recording operation by previously setting and storing start date and time of recording and finish date and time of recording and selection of an input source of image signals to be recorded; wherein when the programs are the programs consisting of a series of programs regularly broadcasted or sent associated with each other, programmed recording setting information such as the start date and time of recording and the finish date and time of recording and the input source of the image signals is recorded on the recording medium so that the recorded programmed recording setting information is used in setting the next programmed recording; and wherein when the recording medium is exchanged with another recording medium in the case where capacity required for recording the programs consisting of a series of programs associated with each other exceeds capacity of a single unit of the recording medium and the programs are divided and recorded on the plurality of recording media, the programmed recording setting information is carried over and recorded on the next recording medium.

4. The recording and playback device according to claim 3, wherein when each program of the series of programs are recorded, each program is given serial number information and recorded on the recording medium; and wherein when capacity required for recording the programs consisting of the series of programs associated with each other exceeds capacity of a single unit of the recording medium and the programs are divided and recorded on the plurality of recording media, programs to be recorded on the plurality of recording media are serially given the serial number information and recorded on the plurality of recording media.

5. The recording and playback device of of claim 1, wherein the serial number information is used as a part of title information when the program is recorded on the recording medium.

6. The recording and playback device of claim 2, wherein medium identifying information for identifying a medium, on which programs immediately before or after are recorded, is recorded on each of the plurality of recording media.

7. The recording and playback device of claim 1, wherein the recording and playback device is a recording and playback device for recording a program on a recording medium in a recording method complying with a DVD Video Recording format, and the serial number information or the programmed recording setting information or the medium identifying information or a combination of the information are stored in Manufacturer's Information Table area in the DVD Video Recording format.

8. A programmed recording program for causing a micro computer provided in a recording and playback device for enabling recording operation of a program on a recording medium to be performed by programmed recording operation by previously setting and storing start date and time of recording and finish date and time of recording and selection of an input source of image signals to be recorded, to execute the steps of: recording programmed recording setting information and serial number information of a program on a first recording medium when programmed recording of the program on the first recording medium is set; using programmed recording setting information recorded on the first recording medium when programmed recording of following programs is set for the first recording medium, and when capacity required for the programmed recording is less than free capacity of the first recording medium, using the programmed recording setting information for setting programmed recording; when the capacity required for the programmed recording exceeds the free capacity of the first recording medium, recording the medium identifying information of a second recording medium on the first recording medium and asking a user to exchange the first recording medium with the second recording medium, and when the first recording medium is exchanged with the second recording medium, recording the programmed recording setting information, the medium identifying information and the serial number information of the first recording medium on the exchanged second recording medium and setting programmed recording by using the programmed recording setting information; and updating the serial number information by using the serial number information as a part of title information in recording process of the programmed recording.

9. The recording and playback device of claim 2, wherein the serial number information is used as a part of title information when the program is recorded on the recording medium.

10. The recording and playback device of claim 4, wherein the serial number information is used as a part of title information when the program is recorded on the recording medium.

11. The recording and playback device of claim 3, wherein medium identifying information for identifying a medium, on which programs immediately before or after are recorded, is recorded on each of the plurality of recording media.

12. The recording and playback device of claim 4, wherein medium identifying information for identifying a medium, on which programs immediately before or after are recorded, is recorded on each of the plurality of recording media.

13. The recording and playback device of claim 2, wherein the recording and playback device is a recording and playback device for recording a program on a recording medium in a recording method complying with a DVD Video Recording format, and the serial number information or the programmed recording setting information or the medium identifying information or a combination of the information are stored in Manufacturer's Information Table area in the DVD Video Recording format.

14. The recording and playback device of claim 3, wherein the recording and playback device is a recording and playback device for recording a program on a recording medium in a recording method complying with a DVD Video Recording format, and the serial number information or the programmed recording setting information or the medium identifying information or a combination of the information are stored in Manufacturer's Information Table area in the DVD Video Recording format.

15. The recording and playback device of claim 4, wherein the recording and playback device is a recording and playback device for recording a program on a recording medium in a recording method complying with a DVD Video Recording format, and the serial number information or the programmed recording setting information or the medium identifying information or a combination of the information are stored in Manufacturer's Information Table area in the DVD Video Recording format.

16. The recording and playback device of claim 5, wherein the recording and playback device is a recording and playback device for recording a program on a recording medium in a recording method complying with a DVD Video Recording format, and the serial number information or the programmed recording setting information or the medium identifying information or a combination of the information are stored in Manufacturer's Information Table area in the DVD Video Recording format.

17. The recording and playback device of claim 6, wherein the recording and playback device is a recording and playback device for recording a program on a recording medium in a recording method complying with a DVD Video Recording format, and the serial number information or the programmed recording setting information or the medium identifying information or a combination of the information are stored in Manufacturer's Information Table area in the DVD Video Recording format.
